(19) United States
(12) Patent Application Publication
(10) Pub. No.: US 2025/0180053 A1
(43) Pub. Date: Jun. 5, 2025

(54) CONNECTION FITTING WITH ARRANGEMENT HAVING TWO INTERCONNECTED COMPONENTS

(71) Applicant: Häfele Berlin GmbH & Co KG, Berlin (DE)

(72) Inventor: Ulrich Merz, Regensburg (DE)

(73) Assignee: Häfele Berlin GmbH & Co KG, Berlin (DE)

(21) Appl. No.: 19/048,072

(22) Filed: Feb. 7, 2025

Related U.S. Application Data
(63) Continuation of application No. PCT/EP2023/071493, filed on Aug. 3, 2023.

(30) Foreign Application Priority Data
Aug. 10, 2022 (DE) 202022104548.8 DE

(51) Int. Cl. F16B 12/20

(52) U.S. Cl. CPC F16B 12/2036

(57) ABSTRACT

A connection fitting for connecting two components has a housing, slide, bolt and control element. The control element is mounted in the housing rotatable about an axis extending obliquely to the bolt axis. The control element has a guide slot having a radially inwardly facing tightening contour and a radially outwardly facing blocking contour. When the control element is rotated out of the initial position in a first portion of the installation rotation, the control element pushes the slide by a stud guided in the guide slot into the front slide end position. In a second portion of the rotation, the slide is locked in the front slide end position by the blocking contour and the bolt is pulled radially inward by the tightening contour engaging behind the undercut, until, at the latest in the end position, the bushing has been spread apart by the spreading head.

### CROSS-REFERENCE TO RELATED APPLICATIONS

This continuation application claims priority to PCT/EP2023/071493 filed on Aug. 3, 2023 which has published as WO 2024/033199 A1 and also the German application number DE 20 2022 104 548.8 filed on Aug. 10, 2022, the entire contents of which are fully incorporated herein with these references.

### DESCRIPTION

### Field of the Invention

The invention relates to a connection fitting for connecting two components, in particular, furniture panels, e.g., structural shelves in cabinets, racks and the like, and an associated arrangement with two interconnected components.

### Background of the Invention

Such connection fittings are sufficiently well known. A connection fitting usually consists of two fitting parts, one of which is secured on the component to be connected and protrudes from the component. This protruding fitting part may snap off from the component during further handling and therefore prevents the storage and delivery of components with pre-installed fitting parts.

Structural shelves are intermediate shelves in cabinet and carcass furniture which, in contrast to pull-out shelves, perform the function of structurally supporting the furniture, being assembled in a fixed manner with the side walls. This is advantageous, particularly in the case of relatively tall cabinets or racks, since bulging of the sides is prevented. To secure structural shelves there are a number of known systems, which either require a beveled surface hole or are inserted into an edge hole or milled feature. The invention is intended to eliminate problems that arise during the installation of structural shelves. These are, on the one hand, the visibility of the connection fittings in the case of surface hole installation and, on the other hand, the necessity of screwing screw-in bolts and the like into the sides.

It is therefore the object of the present invention to specify a novel connection fitting which, in particular, enables the storage, delivery and installation of components, in particular, structural shelves, with pre-installed fitting parts and is furthermore as inconspicuous as possible.

### SUMMARY OF THE INVENTION

According to the invention, this object is achieved by a connection fitting for connecting two components, in particular, furniture panels, comprising: a housing having a housing front side; a slide, which is longitudinally movable in the housing between a rear and a front slide end position, the front slide end of said slide being formed as a bushing which can be spread apart and which in the front slide end position protrudes beyond the housing front side; a bolt, which is arranged longitudinally movably in the slide and which, at one, front bolt end thereof, has a widened spreading head for spreading the bushing apart and which, at the other, rear bolt end thereof, has an undercut facing toward the spreading head; and a control element, which is mounted in the housing so as to be rotatable about an axis of rotation extending obliquely, in particular, at right angles, with respect to the bolt axis and which is rotatable in an installation direction of rotation from an initial position into an installation position, the control element having a guide slot (open, for example, in the axial direction of the axis of rotation), the distance of which from the axis of rotation increases as viewed in the installation direction of rotation, having a radially inwardly facing tightening contour, the distance of which from the axis of rotation increases as viewed in the installation direction of rotation, and having a radially outwardly facing blocking contour, which extends over a circular segment about the axis of rotation; wherein, when the control element is rotated in the installation direction of rotation out of the initial position, in a first portion of the rotation, the control element pushes the slide, by means of a stud guided in the guide slot, into the front slide end position, and, in a second portion of the rotation, the slide is locked in the front slide end position by the blocking contour and the bolt is pulled radially inward by the tightening contour engaging behind the undercut, until, at the latest in the end position, the bushing has been spread apart by the spreading head.

According to the invention, the slide together with the bolt is extended forward by rotating the control element. By further rotation of the control element, the slide is fixed in its front slide end position, and the bolt is pulled radially inward or rearward relative to the fixed slide, as a result of which the bushing is spread apart by the bolt. Overall, an invisible connector is thus provided. The guide slot can be embodied, for example, as a guide track, open on one side, for the stud of the slide.

The guide slot is preferably open at the slot end facing in the installation direction of rotation and/or at the slot end facing counter to the installation direction of rotation. In the former case, the stud can leave the guide slot in the front slide end position and can thus be decoupled from the control element. The slot end facing in the installation direction of rotation preferably widens as viewed in the installation direction of rotation, thus enabling the stud to spring back somewhat in the initial position and enabling the bushing, which may be protruding somewhat, to move back until it ends flush with the housing front side.

In preferred embodiments of the invention, it is envisaged that the spreading head tapers conically in a direction toward its other end, and the bolt has at its rear bolt end a bolt head of any desired shape, on which the undercut is formed. The bolt can, for example, have a bolt stem of round, oval or polygonal, in particular, rectangular or square, cross section to enable it, in the case of a longitudinally slotted bushing, to be guided in a longitudinally movable but non-rotatable manner in the longitudinal slot.

The bushing preferably protrudes beyond the housing front side in the normal position of the connection fitting and can be pushed back out of the normal position, counter to the action of at least one return spring supported on the housing, as far as a position flush with the housing front side.

As a particular preference, in the second portion of the rotation, the blocking contour rests against a bushing rear side of the bushing in order in this way to fix the slide in its front slide end position.

The control element preferably has a bearing journal with an actuating contour, e.g., an internal hexagon, coaxial with the axis of rotation, for rotating the control element. The housing can advantageously have an access opening for the actuating contour in order to enable the control element to be rotated from the outside by means of a tool.

As a particular preference, the control element has an arm which extends in the installation direction of rotation, the inner side of which forms the tightening contour and the outer side of which forms the blocking contour. The arm can be, for example, of single-armed or forked design in order to engage behind the undercut on both sides of the bolt stem in the second portion of the rotation.

The control element preferably has a removal projection, which projects in a direction toward the tightening contour and which, when the control element is rotated out of the end position counter to the installation direction of rotation, pushes the bolt radially outward in order to discontinue the spreading apart of the bushing by the spreading head.

The housing can be a single part, in particular, being foldable by means of a film hinge, or can be assembled from two housing halves, and can have at least one, in particular, a plurality of circumferential ribs, which can dig into the wall of a recess (e.g., single or multiple drill hole or milled feature).

The invention also relates to an arrangement comprising two components, in particular, furniture panels, which are interconnected by means of a connection fitting designed as above, wherein the housing is anchored in a recess (e.g., single or multiple drill hole or milled feature) in one component, and the bushing is anchored in a hole in the other component. The two components can be disassembled by means of an opposite rotary motion of the control element.

Further advantages of the invention will become apparent from the description, the claims and the drawing. The features mentioned above and those presented below can likewise be used individually or together in any desired combinations. The embodiments shown and described should not be understood as an exclusive enumeration; on the contrary they are of an illustrative character intended to describe the invention.

### BRIEF DESCRIPTION OF THE DRAWINGS

In the drawings:

FIGS. 1a-1c show a connection fitting according to the invention for connecting two components in a perspective view (FIG. 1a) and in two different exploded views (FIGS. 1b, 1c), wherein in each case only one of the two housing halves is shown;

FIG. 2 shows a control element shown in FIG. 1;

FIGS. 3a-3f show the mode of operation of the connection fitting according to the invention;

FIG. 4 shows the connection fitting according to the invention in a perspective view;

FIGS. 5a, 5b show two variants of a bolt shown in FIG. 1; and

FIG. 6 shows a variant of a control element shown in FIG. 1.

### DETAILED DESCRIPTION OF EMBODIMENTS OF THE INVENTION

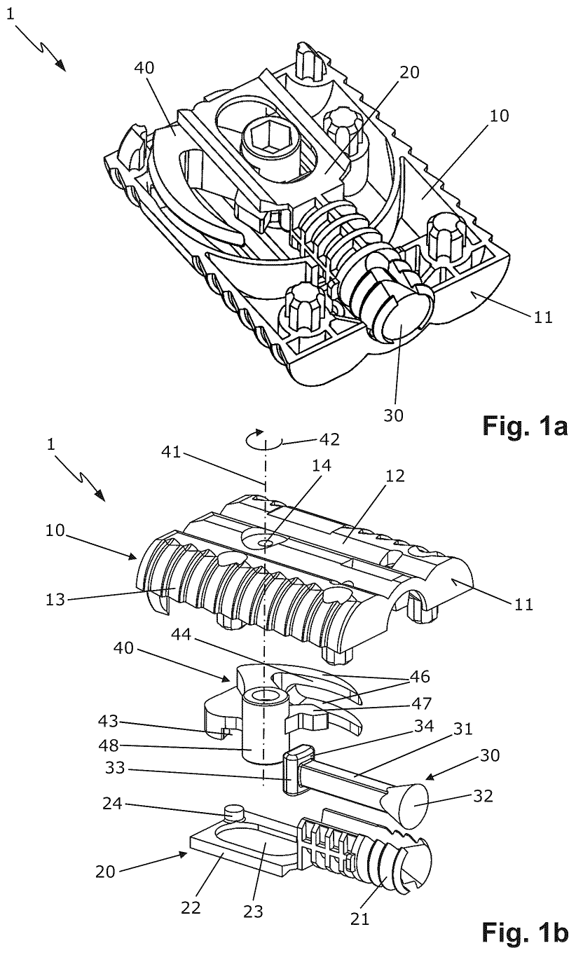

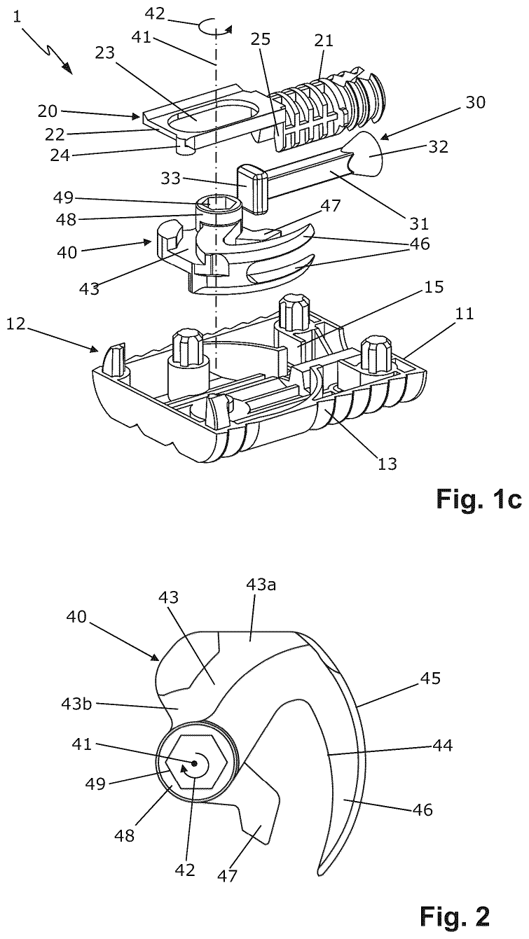

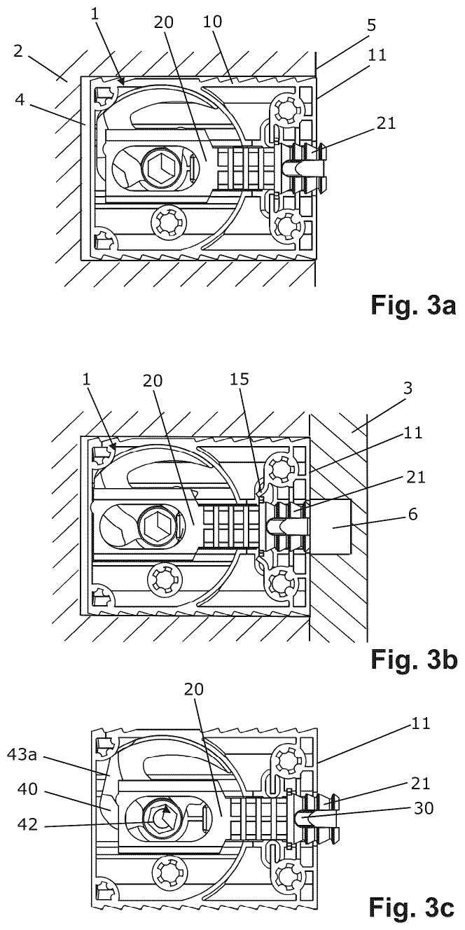

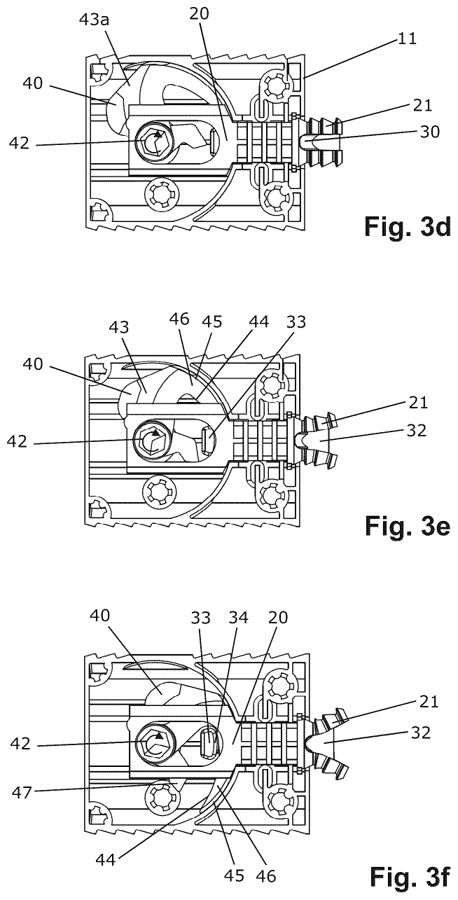

The connection fitting 1 shown in FIGS. 1a-1c is used to connect two components 2, 3 (FIG. 3a), in this case, purely by way of example, in the form of two furniture panels, and comprises the following individual parts: a housing 10 having a housing front side 11; a slide 20, which is arranged in such a way as to be longitudinally movable in the housing 10 between a retracted, rear, and an extended, front, slide end position; a bolt 30, which is arranged longitudinally movably in the slide 20; and a control element 40, which is mounted in the housing 10 so as to be rotatable about an axis of rotation 41 between an initial and an end position.

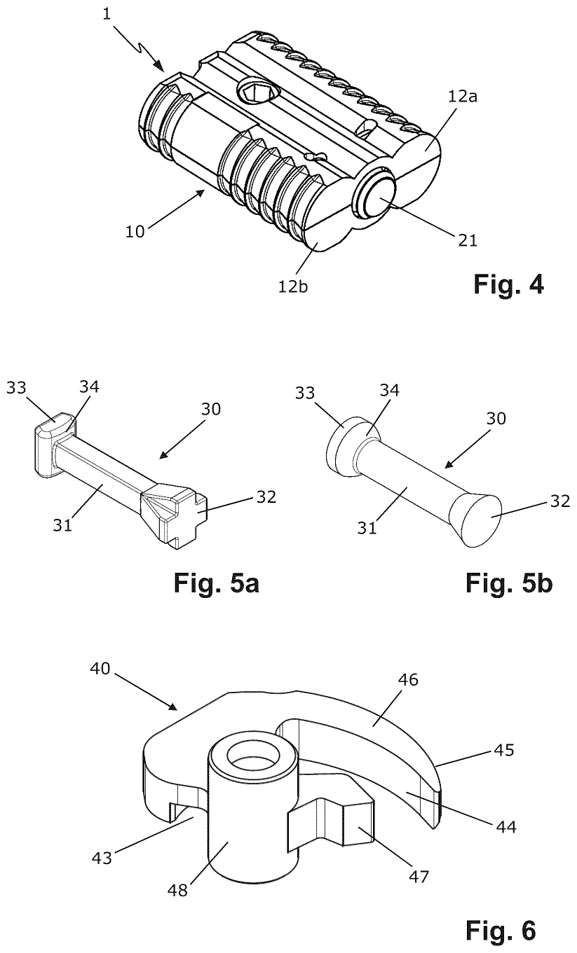

As shown, the housing 10 is preferably assembled from two housing halves 12a, 12b (FIG. 4), of which only one housing half 12a is shown in each of FIGS. 1a-1c. The housing 10 furthermore has one or more circumferential ribs 13.

The front slide end is designed as a bushing 21, in this case longitudinally slotted, which can be spread apart and which protrudes further beyond the housing front side 11 in the front slide end position than in the rear slide end position. The rear slide end is preferably formed by a plate 22, which has an elongate hole (or recess) 23 extending in the longitudinal direction of the slide and a (driver) stud 24 on one of its two main sides. The bushing rear side is denoted by 25.

The bolt 30 has a bolt stem 31, preferably of square cross section, which is arranged longitudinally movably in the bushing 21, and, at its front bolt end, has a spreading head 32, which is widened relative to the bolt stem 31, for spreading apart the bushing 21, and, at its rear bolt end, has a rear bolt head 33, widened relative to the bolt stem 31, which has an undercut 34 facing toward the spreading head 32. The spreading head 32 tapers, preferably conically, in a direction toward the rear bolt head 33.

The control element 40 is mounted in the housing 10 so as to be rotatable about an axis of rotation 41 extending obliquely, in this case at right angles, to the bolt axis, and is rotatable in an installation direction of rotation 42 from an initial position into an end position. The control unit 40 has a guide slot 43, open in the axial direction of the axis of rotation 41, the distance of which from the axis of rotation 41 increases as viewed in the installation direction of rotation 42, a radially inwardly facing tightening contour 44, the distance of which from the axis of rotation 41 increases as viewed in the installation direction of rotation 42, and a radially outwardly facing blocking contour 45, which is arranged radially outwardly in front of the tightening contour 44 and extends over a circular segment about the axis of rotation 41.

The guide slot 43 is open at its two slot ends 43a, 43b in and counter to the installation direction of rotation 42, in each case preferably at the end sides. The slot end 43a facing in the installation direction of rotation 42 is additionally widened.

The tightening contour 44 and the blocking contour 45 are formed by the inner side and the outer side of an arm 46 of the control element 40, which extends in the installation direction of rotation 42. The arm 46 can be of forked design, as shown in the exemplary embodiment.

The control element 40 furthermore has a removal projection 47, which is arranged radially inwardly in front of the tightening contour 44 and projects in a direction toward the tightening contour 44, and a bearing journal 48, which is coaxial with the axis of rotation 41, is in this case circular and passes through the elongate hole 23 of the slide 20, and an actuating contour 49, in this case in the form of a hexagonal opening, which is coaxial with the axis of rotation 41 and is intended for the rotation of the control element 40. The housing 10 has a corresponding access opening 14 for the actuating contour 49. As an option, the slide 20 can also be guided longitudinally movably on the bearing journal 48 by means of its elongate hole 23.

The mode of operation of the connection fitting 1 is described below, wherein, when the control element 40 is rotated in the installation direction of rotation 42 out of the initial position, in a first portion of the rotation α1 (0°≤α1≤ca. 45°), the control element 40 pushes the slide 20, by means of the stud 24 guided in the guide slot 43, into the front slide end position, and, in a second portion of the rotation α2 (ca. 45°≤α2≤ca. 90°), the bushing 21 is spread apart by the spreading head 32. In other embodiments of the invention, the two portions of the rotation α1, α2 can each also be selected so as to be larger or smaller, in particular, the upper limit for the second portion of the rotation α2 can be up to about 120°.

FIG. 3a shows the connection fitting 1 in its normal position, in which the slide 20 is in the front slide position and the bushing 21 protrudes somewhat beyond the housing front side 11. With its housing 10, the connection fitting 1 is anchored flush in a recess 4, here designed as a triple hole, in the first component 2 by means of the circumferential ribs 13, with the result that the bushing 21 protrudes somewhat beyond the edge 5 of the first component 2. As an alternative, however, it is also possible in the normal position of the connection fitting 1 for the bushing 21 to end flush with the housing front side 11, as shown in FIG. 3b, and thus also flush with the edge 5. The access opening 14 or the actuating contour 49 are accessible via a transverse hole in the first component 2, thus enabling the control element 40 to be rotated from outside by means of a tool.

In FIG. 3b, the first component 2 is placed with its edge 5 on the second component 3. The widened slot end 43a enables the stud 24 to spring back counter to the action of return springs 15, thus enabling the bushing 21 to move back until it ends flush with the housing front side 11 and thus also with the edge 5. Here, the return springs 15 are molded onto the housing 10 but, as an alternative, could also be molded onto the bushing 21.

When the control element 40 is rotated in the installation direction of rotation 42 out of the initial position, in the first portion of the rotation (“pre-installation”), the slide 20 is extended forward by the control element 40 by means of the stud 24 guided in the guide slot 43. In FIG. 3c, the control element 40 has been rotated by about 15° in the installation direction of rotation 42 out of the initial position and, as a result, the slide 20, together with the bolt 30, has been extended into an intermediate position, in which the bushing 21 protrudes beyond the housing front side 11 and engages in a bore 6 in the second component 3. In FIG. 3d, the control element 40 has been rotated by about 45° in the installation direction of rotation 42 out of the initial position and, as a result, the slide 20, together with the bolt 30, has been extended into the front slide end position, in which the bushing 21 in each case protrudes to the maximum extent beyond the housing front side 11 and engages in the bore 6. In the front slide end position, the stud 24 has left the slot end 43b and is thus decoupled from the control element 40.

In the second portion of the rotation (“retention”), on the one hand the slide 20 is locked in the front slide end position by the blocking contour 45 of the control element 40 in that the blocking contour 45 rests against a bushing rear side 25, and on the other hand the bolt 30 is pulled radially inward by the tightening contour 44, which engages behind the undercut 34, until, at the latest in the end position, the bushing 21 is spread apart by the spreading head 32. Owing to its forked design, the arm 46 engages behind the undercut 34 on both sides of the bolt stem 31.

In FIG. 3e, the control element 40 has been rotated by about 60° in the installation direction of rotation 42 out of the initial position, and the bushing 21 has already been spread apart and anchored in the bore 6 by the spreading head 32. In FIG. 3f, the control element 40 has been rotated by about 90° in the installation direction of rotation 42 out of the initial position and into the end position, and the bushing 21 has been fully spread apart and firmly anchored in the bore 6 by the spreading head 32.

When the control element 40 is rotated counter to the installation direction of rotation 42 out of the end position, the removal projection 47 comes into contact with the rear bulkhead 33 and pushes the bolt 30 radially outward in the second portion of the rotation α2, as a result of which the bushing 21 is no longer spread apart by the spreading head 32. In the first portion of the rotation α1, the slide 20 can move back into the rear slide end position again.

FIG. 4 shows the connection fitting 1 in its normal position, said fitting having the housing 10 assembled from two housing halves 12a, 12b. Alternatively, the housing may also be of one-piece design, in particular, being foldable by means of a film hinge.

The two bolt variants shown in FIGS. 5a, 5b differ from the bolt 30 shown in FIG. 1 in that, in FIG. 5a, the spreading head 32 is cross-shaped in cross section and, in FIG. 5b, the bolt stem and the rear bolt head 33 are of round design.

The variant shown in FIG. 6 differs from the control element 40 shown in FIG. 1 only in that, in this case, the control element 40 has only a single-armed arm 46.

What is claimed is:

1. A connection fitting for connecting two components, comprising:
a housing having a housing front side;
a slide, which is longitudinally movable in the housing between a rear and a front slide end position, the front slide end of said slide being formed as a bushing which can be spread apart and which in the front slide end position protrudes beyond the housing front side;
a bolt, which is arranged longitudinally movably in the slide and which, at one, front bolt end thereof, has a widened spreading head for spreading the bushing apart and which, at the other, rear bolt end thereof, has an undercut facing toward the spreading head; and
a control element, which is mounted in the housing configured to be rotatable about an axis of rotation extending obliquely with respect to the bolt axis and which is rotatable in an installation direction of rotation from an initial position into an end position, the control element having a guide slot, the distance of which from the axis of rotation increases as viewed in the installation direction of rotation, having a radially inwardly facing tightening contour, the distance of which from the axis of rotation increases as viewed in the installation direction of rotation, and having a radially outwardly facing blocking contour, which extends over a circular segment about the axis of rotation;
wherein, when the control element is rotated in the installation direction of rotation out of the initial position, in a first portion of the rotation, the control element pushes the slide, by means of a stud guided in the guide slot, into the front slide end position, and, in a second portion of the rotation, the slide is locked in the front slide end position by the blocking contour and the bolt is pulled radially inward by the tightening contour engaging behind the undercut, until, at the latest in the end position, the bushing has been spread apart by the spreading head.

2. The connection fitting as claimed in claim 1, wherein the end of the guide slot is open at the slot end facing in the installation direction of rotation and/or at the slot end facing counter to the installation direction of rotation.

3. The connection fitting as claimed in claim 1, wherein the slot end facing in the installation direction of rotation is widened as viewed in the installation direction of rotation.

4. The connection fitting as claimed in claim 1, wherein the spreading head tapers conically in a direction toward the rear bolt end.

5. The connection fitting as claimed in claim 1, wherein the bolt has at its rear bolt end a rear bolt head, on which the undercut is formed.

6. The connection fitting as claimed in claim 1, wherein the bushing protrudes beyond the housing front side in a normal position of the connection fitting and can be pushed back out of the normal position, counter to the action of at least one return spring supported on the housing, as far as a position flush with the housing front side.

7. The connection fitting as claimed in claim 1, wherein, in the second portion of the rotation, the blocking contour rests against a bushing rear side of the bushing.

8. The connection fitting as claimed in claim 1, wherein the control element has a bearing journal with an actuating contour, coaxial with the axis of rotation, for rotating the control element.

9. The connection fitting as claimed in claim 8, wherein the housing has an access opening for the actuating contour.

10. The connection fitting as claimed in claim 1, wherein the control element has an arm which extends in the installation direction of rotation, the inner side of which forms the tightening contour and the outer side of which forms the blocking contour.

11. The connection fitting as claimed in claim 10, wherein the arm is of forked design configured to engage behind the undercut on both sides of a bolt stem in the second portion of the rotation.

12. The connection fitting as claimed in claim 1, wherein the control element has a removal projection, which projects in a direction toward the tightening contour and which, when the control element is rotated out of the end position counter to the installation direction of rotation, pushes the bolt radially outward in order to discontinue the spreading apart of the bushing by the spreading head.

13. The connection fitting as claimed in claim 1, wherein the housing is assembled from two housing halves.

14. The connection fitting as claimed in claim 1, wherein the housing has at least one circumferential rib.

15. The connection fitting as claimed in claim 1, wherein the housing has a plurality of circumferential ribs.

16. An arrangement comprising the two components which are interconnected by means of the connection fitting as claimed in claim 1, wherein the housing is anchored in a recess in one component, and the bushing is anchored in a bore in the other component.
